(19) United States
(12) Patent Application Publication
(10) Pub. No.: US 2014/0299154 A1
(43) Pub. Date: Oct. 9, 2014

(54) SCRAPER DEVICE FOR CLEANING A SUBMERGED SURFACE

(71) Applicant: James Keane, Sanford, FL (US)

(72) Inventor: James Keane, Sanford, FL (US)

(21) Appl. No.: 14/176,480

(22) Filed: Feb. 10, 2014

Related U.S. Application Data
(63) Continuation of application No. 13/347,209, filed on Jan. 10, 2012, now abandoned.
(60) Provisional application No. 61/431,503, filed on Jan. 11, 2011.

(51) Int. Cl. E04H 4/16; B08B 1/00

(52) U.S. Cl. CPC E04H 4/1609; B08B 1/005; B08B 1/002
USPC 134/6; 15/236.01

(57) ABSTRACT

Disclosed is a scraper device for cleaning an exterior of a watercraft and/or a seawall. The scraper device has a flap component that urges the scraper device against a surface upon movement in a first and second opposing directions.

### CROSS-REFERENCE TO RELATED APPLICATIONS

This application is a continuation application of U.S. application Ser. No. 13/347,209 filed Jan. 10, 2012. This application is also related to U.S. Provisional Application No. 61/431,503 filed Jan. 11, 2011 to which priority is claimed under 35 USC 119. These applications are incorporated herein by reference.

### FIELD OF THE INVENTION

The invention relates to scraper devices, and in particular, to scraper devices used for cleaning an underwater surface, such as the exterior of a watercraft and/or a seawall.

### BACKGROUND OF THE INVENTION

Regular maintenance of pools involves the cleaning of the interior walls of the pool, including the side walls and bottom, to remove dirt and algae. In order to clean the pool interior, brush devices have been introduced, to ease the process. For example, U.S. Pat. No. 7,353,559 to Blackwell discloses a pool brush which is used to clean the interior of the pool in a single direction. Additionally, U.S. Patent Publication No. 2003/0102009 to Fortier discloses a pool brush which is used to clean the interior of the pool in more than one direction. However, the inventor has now realized that these conventional pool brushes have shortcomings which limit their effectiveness in cleaning the interior of the pool. The pool brush disclosed in Blackwell is solely used in a single direction, and thus would require twice the effort or number of brush strokes to clean the pool. The pool brush disclosed in Fortier has structural limitations which limit its ability to clean the pool interior in more than one direction.

Accordingly, there is a need in the industry to provide a pool brush which is capable of cleaning the pool interior in more than one direction, with maximum efficiency. Thus, it would be advantageous to provide such a pool brush.

### BRIEF DESCRIPTION OF THE INVENTION

In one embodiment of the present invention, a brush device is provided for cleaning an interior of a pool. The brush device includes a brush component having a base with a back portion and a front portion. Bristles are configured to extend from the front portion. Additionally, the brush device includes a flap portion pivotally mounted to the back portion of the base. During the cleaning of the interior of the pool, the flap portion pivots from a first position to a second position, during a first direction of motion of the brush component along the interior of the pool. Additionally, during the cleaning of the interior of the pool, the flap portion pivots from the second position to the first position, during a second direction of motion of the brush component along the interior of the pool. The second direction is opposite in direction to the first direction.

In another embodiment of the present invention, a brush device is provided for cleaning an interior of a pool. The brush device includes a brush portion and a flap portion pivotally mounted to the brush portion. During a first direction and a second direction of motion of the brush component along the interior, the flap portion pivots with respect to the brush portion, to enhance a frictional force between the brush portion and the interior. The first direction is opposite to the second direction.

In another embodiment of the present invention, a method is provided for cleaning an interior of a pool. The method begins by directing a brush component along an interior of a pool in a first direction of motion. The method subsequently involves pivoting a flap portion about the brush component from a first position to a second position. The method further includes directing the brush component along the interior of the pool in a second direction of motion, where the second direction of motion is opposite to the first direction of motion. The method subsequently involves pivoting the flap portion about the brush component from the second position to the first position.

### BRIEF DESCRIPTION OF THE DRAWINGS

FIG. 1 is an isolated perspective view of an exemplary embodiment of a brush device in accordance with the present invention;

FIG. 2 is a perspective view of the brush device of FIG. 1 along an interior of a pool during an upward motion of the brush device;

FIG. 3 is a perspective view of the brush device of FIG. 1 along an interior of a pool during a downward motion of the brush device;

FIG. 4 is a flow chart illustrating an exemplary embodiment of a method for cleaning an interior of a pool in accordance with the present invention; and

FIG. 5 is an isolated perspective view of an exemplary embodiment of a scraper device in accordance with the present invention.

### DETAILED DESCRIPTION

Though exemplary embodiments of the present invention are described with respect to pool brushes, embodiments of the invention are applicable for use in other pool cleaning devices, or any underwater cleaning device which is in contact with an interior of the pool or holding vessel for the water, for purposes of cleaning the interior.

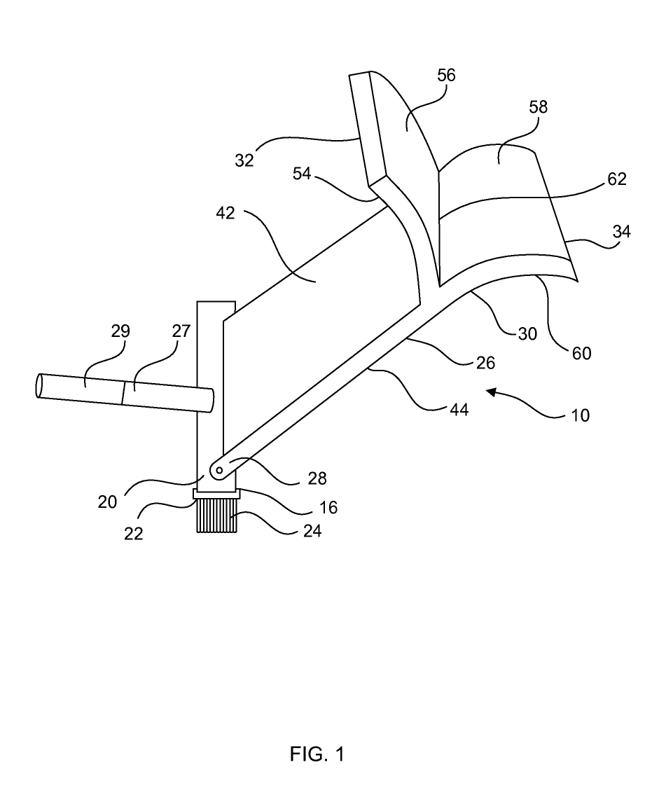

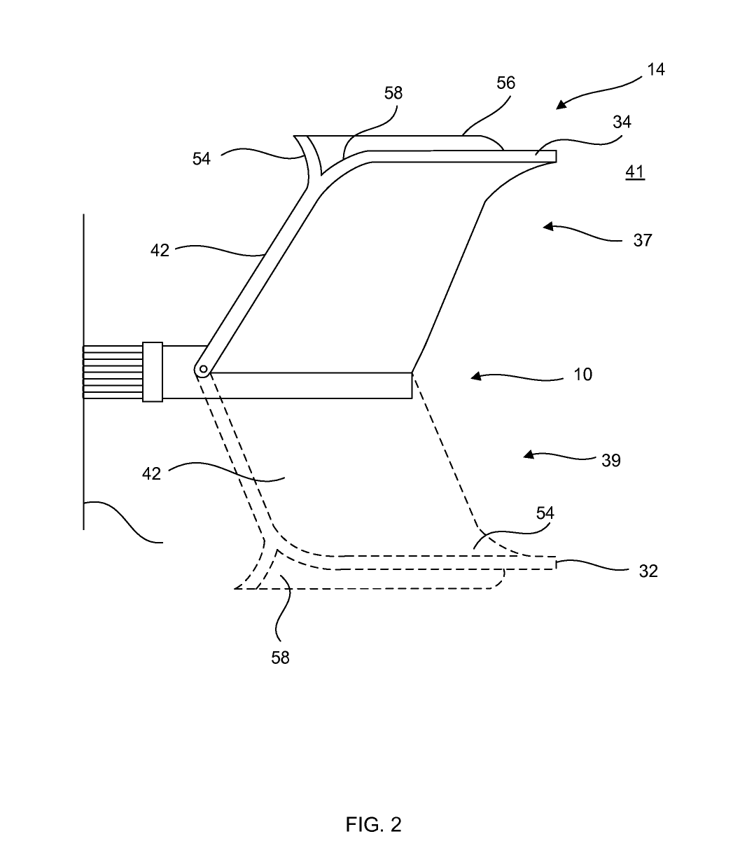

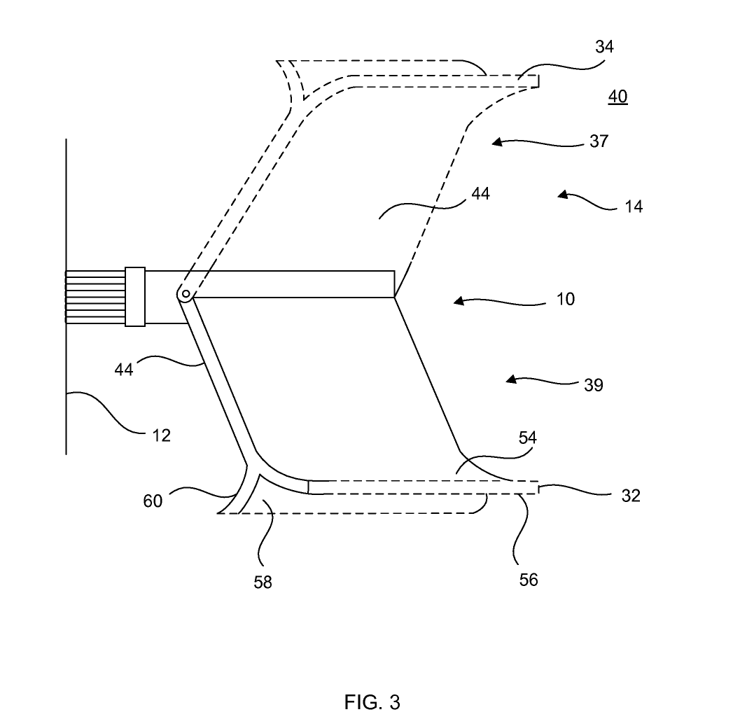

FIG. 1 illustrates an exemplary embodiment of a brush device 10 for cleaning an interior 12 (FIGS. 2-3) of a pool 14. The brush device 10 includes a brush component 16 having a base with a back portion 20 and a front portion 22, where bristles 24 extend from the front portion 22 and frictionally engage the interior 12 of the pool 14. Additionally, as illustrated in FIG. 1, a flap portion 26 is pivotally mounted to the back portion 20. An extension attachment 27 extends from the base of the brush component 16, and an extension rod 29 is attachable to the extension attachment 27, such that the brush device 10 may be handled by a user standing outside the pool, and the extension rod 29 is sized such that the user may extend the brush device 10 to the deepest interior 12 of the pool. Although the embodiments of the present invention discuss an upward and downward motion of the brush component 16 along the interior 12, the brush device 10 may be utilized over the interior bottom of the pool, as well as the interior side of the pool. Although FIG. 1 illustrates that the bristles 24 extend from the front portion 22, the brush device 10 may, in an alternative embodiment, include a roller brush having roller bristles, which is rotatably attached to the flap portion, for example. The flap portion 26 may be pivotally mounted to the back portion 20, using any conventional method known to one of skill in the art.

As illustrated in FIG. 2, during an upward motion 41 of the brush component 26 along the interior 12 of the pool 14, the flap portion 26 pivots from a upward position 37 to a lower position 39. Similarly, as illustrated in FIG. 3, during a downward motion 40 of the brush component 26 along the interior 12 of the pool 14, the flap portion 26 pivots from a lower position 39 to an upward position 37. During both of the upward and downward motions 41,40, the brush component 26 frictionally engages the interior 12 of the pool 14. The upward/lower positions are determined based on the relative position of the flap portion 26, relative to the brush component 16, rather than the absolute height of the flap portion 26 within the pool 14. However, the first end 28 of the flap portion 26 includes an upward stop 35, to stop a pivot of the flap portion 26 from the lower position 39 to the upward position 37 and/or to hold the flap portion in the upward position 37, based on a contact made between the upward stop 35 and the back portion 20 of the brush component 26. Similarly, the first end 28 of the flap portion 26 includes a lower stop 33, to stop a pivot of the flap portion 26 from the upward position 37 to the lower position 39 and/or to hold the flap portion 26 in the lower position 39, based on a contact made between the lower stop 33 and the back portion 20 of the brush component 26. The lower and upward stops 33,35 of the first end 28 may be adjustably shaped, to correspondingly adjust the respective lower and upward positions 39,37 at which the stops 33,35 stop the pivot of the flap portion 26. In an exemplary embodiment, the relative upward/lower motion/position, are determined, relative to the surface of the pool 14, for example. In an exemplary embodiment, the upward motion 41 is opposite in direction to the downward motion 40, along the interior 12 of the pool 14. As discussed previously, however, the embodiments of the present invention are not limited to a vertical upward/downward motion along the interior of the pool, and include, side-to-side motion along the side interior and bottom interior of the pool, for example.

As illustrated in FIG. 1, the flap portion 26 includes a first and second side 42,44, and the pivot of the flap portion 26 during the motion of the brush component 26 is based on a force being imparted on a respective side 42,44 of the flap portion 26 during the motion of the brush component 26. The force is imparted by water within the pool 14, based on the relative motion of the brush device 10 through the pool 14. For example, during the upward motion 41 of FIG. 2, during the initial phase of the pivot from the upward position 37, the force pivots the first side 42 away from the upward position 37, where the first side 42 is positioned adjacent to (i.e., facing more toward than away from) the interior 12 of the pool 14. During a subsequent phase of the pivot to the lower position 39, the force pivots the first side 42 to the lower position 39, where the first side 42 is positioned away from the interior 12 of the pool 14. Once the flap portion 26 has been pivoted to the lower position 39, such that the first side 42 is positioned away from the interior 12 of the pool 14, a lateral force is imparted on the first side 42 during the upward motion 41 of the brush component 26, to enhance a frictional force between the brush component 26 and the interior 12 of the pool 14, during the motion of the brush component 26 along the interior 12 of the pool 14. The lateral force is imparted by the flap portion 26 onto the brush component 16, as distinct from the lateral force imparted on the flap portion 26 by the water within the pool 14. In a similar example, during the downward motion 40 of FIG. 3, during the initial phase of the pivot from the lower position 39, the force pivots the second side 44 out from the lower position 39, where the second side 44 is positioned adjacent to the interior 12 of the pool 14. During a subsequent phase of the pivot to the upward position 37, the force pivots the second side 44 to the upward position 37, where the second side 44 is positioned away from the interior 12 of the pool 14.

As further illustrated in FIG. 1, the flap portion 26 includes a first and second end 28,30, where the first end 28 is pivotally mounted to the back portion 20 of the base. As discussed above, any conventional method may be used to pivotally mount the first end 28 of the flap portion 26 to the first end 28. As further illustrated in FIG. 1, the second end 30 diverges into a first and second flared surface 32,34, where the first flared surface 32 diverges on a same side of the flap portion 26 as the first side 42, and the second flared surface 34 diverges on a same side of the flap portion 26 as the second side 44. The pivot of the flap portion 26 during the motion of the brush component 16 is based on a force imparted on one of the first and second sides 42,44 and one of the first and second flared surfaces 32,34, during the motion of the brush component 16.

In the illustrated embodiment of FIG. 2, during the initial phase of the pivot of the flap portion 26 from the upward position 37, during the upward motion 41 of the brush component 16, the force is imparted on the first side 42 and the first flared surface 32, to pivot the first side 42 out from being adjacent to the interior 12 of the pool 14. Additionally, during a subsequent phase of the pivot, the force is imparted on the first side 42 and the first flared surface 32, to pivot the first side 42 to be positioned away from the interior 12 of the pool 14. In the illustrated embodiment of FIG. 3, during the initial phase of the pivot of the flap portion 26 from the lower position 39, during the downward motion 40 of the brush component 16, the force is imparted on the second side 44 and the second flared surface 34, to pivot the second side 44 out from being adjacent to the interior of the interior 12 of the pool 14. Additionally, during a subsequent phase of the pivot, the force is imparted on the second side 44 and the second flared surface 34, to pivot the second side 44 to be positioned away from the interior 12 of the pool 14.

As further illustrated in FIG. 1, the first and second flared surfaces 32,34, have a respective first and second side (54,56) (58,60), based on the first and second side 42,44 of the elongated portion 26. Thus, for example, the first and second sides 54,56 of the first flared surface 32 have an equivalent convention as the first and second sides 42,44 of the flap portion 26. As illustrated in FIG. 1, the second side 56 of the first flared surface 32 is adjacent to the first side 58 of the second flared surface 34, and the second side 56 of the first flared surface 32 merges with the first side 58 of the second flared surface 34 at a cleavage segment 62 at the second end 30 of the flap portion 26.

During an initial phase of the pivot, the force is imparted along a respective first and second side 42,44 of the flap portion 26 and a may be imparted to the respective first side 58 of the second flared surface 34 and the second side 56 of the first flared surface 32.

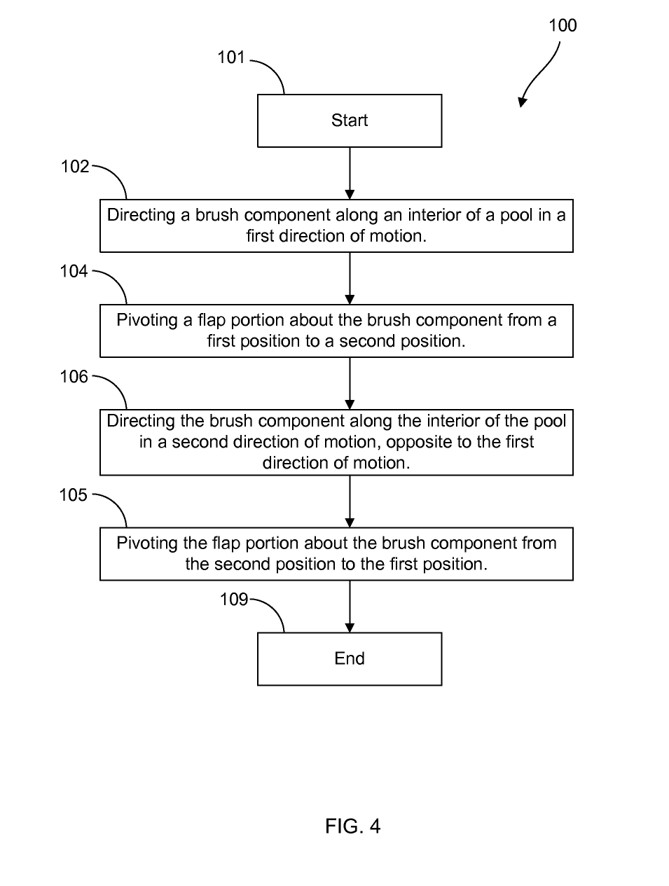

FIG. 4 illustrates a flow chart depicting an exemplary embodiment of a method 100 for cleaning the interior 12 of the pool 14. The method 100 begins at 101 by directing 102 the brush component 16 along the interior 12 of the pool 14 in a first direction of motion. The method 100 further includes pivoting 104 a flap portion 26 about the brush component 16 from a first position to a second position. The method 100 further includes directing 106 the brush component 16 along the interior 12 of the pool 14 in a second direction of motion, where the second direction of motion is opposite to the first direction of motion. The method 100 further includes pivoting 108 the flap portion 26 about the brush component 16 from the second position to the first position, before ending at 109.

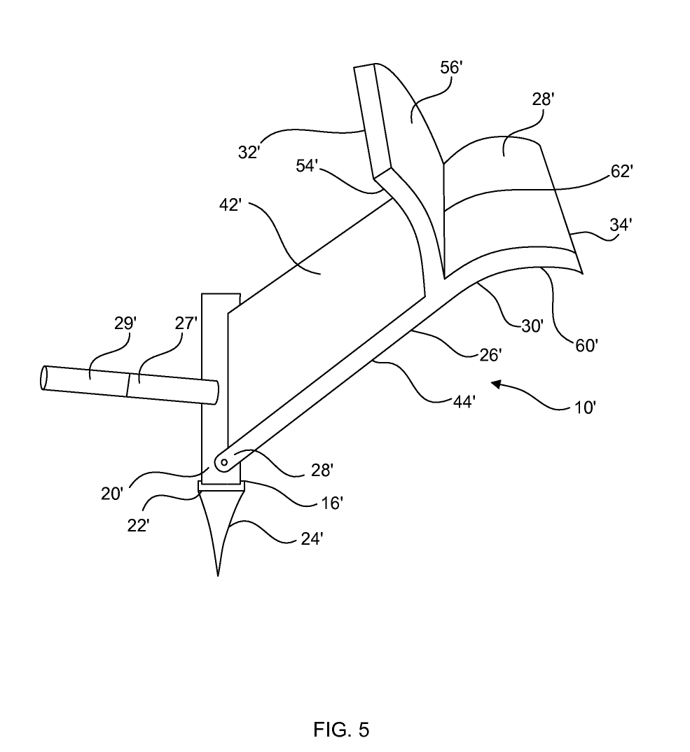

FIG. 5 illustrates an exemplary embodiment of a scrape device 10′ for cleaning an exterior of a watercraft and/or a seawall. The scrape device 10′ includes a scrape device 16′ having a base with a back portion 20′ and a front portion 22′, where a scraper 24′ extends from the front portion 22′. In an exemplary embodiment, the scraper 24′ may be an elongated blade, made from a metal-based material, whose width continuously narrows to a tip of the scraper 24′ at an opposite end from the front portion 22′. The scrape device 10′ is similar to the brush device 10 disclosed above and illustrated in FIGS. 1-3, with respect to a flap portion 26′ of the scrape device 10′, which operates in a similar manner as the flap portion 26 of the brush device 10, during a motion of the scrape device 10′ in opposing directions along the exterior of the watercraft and/or the seawall. Additionally, an extension attachment 27′ extends from the base of the scrape component 16′, and an extension rod 29′ is attachable to the extension attachment 27′, such that the scrape device 10′ may be handled by a user standing on a dock at which the watercraft is docked, for example. Those number references of the scrape device 10′ not discussed above, and illustrated in FIG. 5, are similar to the corresponding number reference discussed above in the embodiment of the brush device 10, without prime notation, and require no further discussion herein. In an additional exemplary embodiment, the scrape device 10′ may be utilized to cleaning the exterior of dock pilings, and a rounded attachment (not shown) may be secured to the scrape device 10′, such that the scraper 24′ follows the rounded exterior surface of the dock pilings, to effectively clean the exterior of the dock pilings.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A scraper device for cleaning a surface, said scraper device comprising:
a base component with a back portion and a front portion;
a blade component extending from said front portion; and
a flap portion having a first end pivotally mounted to the base component, and a second end having a divergent respective first and second flared surface;
wherein during a first direction and a second direction of motion of said base component along said surface, said flap portion is configured to pivot with respect to the based component, to urge a frictional force between the scraper blade component and the surface; and wherein said first direction is opposite to the second direction.

2. The device of claim 1, wherein said blade component is comprised of metal.

3. The device of claim 1, further comprising an extension attachment that extends from the base component.

4. The device of claim 3, further comprising an extension rod that is attached to the extension attachment.

5. A method for cleaning an exterior of a watercraft comprising:
directing a blade component along said exterior in a first direction of motion;
pivoting a flap portion about the blade component from a first position to a second position;
directing the blade component along said exterior in a second direction of motion, said second direction of motion being opposite to the first direction of motion; and
pivoting the flap portion about the blade component from the second position to the first position.

6. The method of claim 5, wherein said first direction is an upward direction of motion, said second direction is a downward direction of motion; said first position is an upper position; said second position is a lower position.

7. The method of claim 5, further comprising:
imparting a force on a respective side of the flap portion, during the directing steps.

8. The method of claim 7, wherein said pivoting comprises:
initially pivoting said respective side of the flap portion from one of the respective first and second position, said respective first and second position based on said respective side being positioned adjacent to said exterior; and
subsequently pivoting said respective side of the flap portion to one of said respective second and first position, said respective second and first position based on said respective side being positioned opposite to said exterior.

9. The method of claim 8, wherein upon said subsequently pivoting, said imparting is imparting a lateral force on said respective side during the motion of said blade component, and said method further includes:
enhancing a frictional force between said blade component and said exterior, during said motion of said blade component along said exterior.
